(19) United States
(12) Patent Application Publication
(10) Pub. No.: US 2022/0196088 A1
(43) Pub. Date: Jun. 23, 2022

(54) HYDRAULIC BRAKE MOTOR DEVICE

(71) Applicant: Zhenjiang Dali Hydraulic Motor Co., Ltd., Zhenjiang, Jiangsu (CN)

(72) Inventor: Zhisheng WANG, Zhenjiang (CN)

(21) Appl. No.: 17/612,608

(22) PCT Filed: May 22, 2020
(86) PCT No.: PCT/CN2020/091845

§ 371 Date: Nov. 19, 2021

(30) Foreign Application Priority Data
May 23, 2019 (CN) 201910432299.0

(51) Int. Cl. F16D 55/40; F16D 65/18

(52) U.S. Cl. CPC F16D 55/40; F16D 2121/04; F16D 65/18

(57) ABSTRACT

A hydraulic brake motor device, including a motor positioning, installation and driving portion, a motor body meshing pair portion, and a motor brake device portion. A shuttle valve is integrated inside the hydraulic brake motor device and configured to relieve pressure inside the motor brake device portion. The shuttle valve includes two separate functional parts of check valves.

### CROSS-REFERENCE TO RELATED APPLICATIONS

This application is a U.S. National Phase application submitted under 35 U.S.C. § 371 of Patent Cooperation Treaty application serial no. PCT/CN2020/091845, filed May 22, 2020, and entitled HYDRAULIC BRAKE MOTOR DEVICE, which application claims priority to Chinese patent application serial no. 201910432299.0, filed May 23, 2019. Patent Cooperation Treaty application serial no. PCT/CN2020/091845, published as WO 2020/233714, and Chinese patent application serial no. 201910432299.0, are incorporated herein by reference.

### TECHNICAL FIELD

The present disclosure relates to the technical field of hydraulic transmission, and more particularly relates to a hydraulic brake motor device.

### BACKGROUND

The hydraulic brake device is used in a wide range. The hydraulic brake device typically adopts a normally-closed braking mode and is used compatibly with and driven by a cycloid hydraulic motor. The hydraulic brake device mainly consists of a friction pair including a steel sheet and a friction sheet, a brake oil port control piston and an elastic support body, and has the drawbacks of large radial dimensions and a complex structure. The brake oil port is provided by an external oil passage, and has other structures. For example, Chinese Patent Application No. 201020295871.8 discloses a brake device without friction pair, in which a shuttle valve for a brake oil port is disposed on a housing, arranged in an axial direction, and is in communication with an oil port A and an oil port B through a pore canal and a tube cap. However, the arrangement of the shuttle valve causes the structure of the housing large and too complex, and a common and standard housing for mounting flange cannot be selected to be used, and a housing has to be specially designed to match the increased volume due to the arrangement of the shuttle valve, thereby hindering the application of the brake device having a connection mode for the existing standard cycloid hydraulic motor.

Similarly, Chinese Patent Application No. 201620994964.7 also discloses a brake device without friction pair, in which a shuttle valve for a brake oil port is disposed on a brake housing and arranged in the axial direction. A brake and control oil passage is used as a passage via a bolt hole. The shuttle valve is in communication with a small inclined hole at the high pressure end of the check valve of the motor housing by means of the bolt hole, so as to communicate with an oil port A and an oil port B in the housing. What's more, the small-sized inclined hole is used to communicate with the front and rear oil passages of the axial shuttle valve within a piston seat. The small-sized inclined hole of the brake device is difficult to process, especially for a hole with a mall angle in the axial direction, the precision requirement therefor is high, and a processing error may cause unreliability of the brake and control oil passage, thereby hindering the application of the brake device having a connection mode for the standard existing cycloid hydraulic motor.

In order to adapt to the development and change of the application field and to provide a reliable hydraulic brake device, it is necessary to directly and conveniently replace the existing connection mode in which the standard cycloid hydraulic motor is in communication with the brake device. In addition, the structure of the existing hydraulic motor is complex, or the manufacturing process thereof is complex, or the brake flow passage thereof is complex and difficult to process, resulting in lower reliability in the product, or the cost of the externally disposed shuttle valve is high, it is difficult to for the existing hydraulic motor to meet the market requirement.

### SUMMARY

In view of the above defects, the present application discloses a hydraulic brake motor device.

The hydraulic brake motor device includes a motor positioning, installation and driving portion, a motor body meshing pair portion and a motor brake device portion. A shuttle valve is integrated inside the hydraulic brake motor device and configured to release pressure in the motor brake device portion. The shuttle valve comprises two separate check-valve-functional parts.

In some embodiments, the motor brake device portion comprises a brake housing. Each of the check-valve-functional parts comprises a steel ball, a valve seat, a first O-ring, and a tube cap.

One end of the valve seat is provided with a stepped shaft and a groove; and the valve seat is disposed inside the brake housing and isolated from an external environment by the tube cap disposed at an edge of the brake housing.

The first O-ring is disposed on the stepped shaft to seal the valve seat and the brake housing.

A location-limiting means is provided at one end of the valve seat touching the steel ball, so that high-pressure oil between the steel ball and the valve seat has an unidirectional flow characteristic.

In some embodiments, the valve seat is provided with stepped through holes therein. A radius of a relatively small hole of the stepped through holes is smaller than a radius of the steel ball; the steel ball is arranged in a relatively large hole of the stepped through holes. The location-limiting means is a radius-changed region adjacent to the relatively small hole of the stepped through holes.

In some embodiments, the motor brake device portion further includes a piston, a second O-ring, a first retaining ring, a third O-ring, and a second retaining ring; and one end of the brake housing forms a stepped hole.

The piston is inserted into and connected to the stepped hole of the brake housing; and two surfaces of the piston opposite to the stepped hole in an axial direction each are provided with a recess.

The second O-ring and the first retaining ring are disposed in one recess, and the third O-ring and the second retaining ring are disposed in another recess.

A surface of the brake housing in a radial direction is spaced apart from an opposite surface of the piston forming a brake oil chamber.

In some embodiments, the two separate check-valve-functional parts are arranged radially on the brake housing in a radial direction, and are in communication with each other through the brake oil chamber.

In some embodiments, the motor brake device portion further includes a rear steel sheet, a rear cover, a first spring, and a second spring.

The rear steel sheet is inserted in an end of the brake housing facing away from the piston and abuts against the piston.

An annular groove is formed on an outer wall of one end of the piston facing away from the brake housing.

The second spring is sleeved in the first spring and disposed within the annular groove, and the first spring and the second spring abut against opposite two surfaces of the piston and the rear cover.

In some embodiments, the brake housing is provided with a first hole passage, and the check-valve-functional parts are in communication with the brake oil chamber through the first hole passage.

In some embodiments, the motor positioning, installation and driving portion is provided with a first oil port and a second oil port. The motor positioning, installation and driving portion, the motor body meshing pair portion, and the motor brake device portion are provided with a second hole passage. The check-valve-functional parts are in communication with the first oil port and the second oil port, respectively through the second hole passage.

In some embodiments, the motor positioning, installation and driving portion includes a housing and a partition plate. The first oil port and the second oil port are disposed in the housing. The housing abuts against the partition plate. The second hole passage comprises a first passage communicating with the partition plate and the housing, respectively, a second passage provided in a stator of the motor body meshing pair portion, and a third passage provided in the brake housing.

In some embodiments, the motor body meshing pair portion includes a rotor and stator pair and a linkage shaft. The motor brake device portion further includes a brake seat, a friction sheet, and a steel sheet. The friction sheet and the steel sheet form a friction pair disposed in an inner cavity of the brake seat; a first key on the linkage shaft engages with a second key inside the friction pair; and a location of the friction pair is limited by connecting bolts arranged in a circumferential direction of the friction pair.

From the above technical solutions, the present application discloses a hydraulic brake motor device. The two separate check-valve-functional parts skillfully utilizes a reverse action function of the high-pressure oil of the cycloid hydraulic motor check valve. When there is high-pressure oil in the first oil port A and the second oil port B, the two check-valve-functional parts are in communication with each other by means of the brake oil chamber, so that the oil passes through the check-valve-functional parts. In this way, the hydraulic brake motor device has a shuttle valve function with a controlling and braking function, thereby eliminating an external shuttle valve and a brake oil pipe of a braker, which are provided for the conventional motor. What's more, by skillfully utilizing the connecting bolts to circumferentially limit the friction pair and utilizing the externally extended first key on the linkage shaft engaging the second key inside the friction pair, the braking structure is reliable and compact. In particular, the radical arranged check-valve-functional parts make the machining process for the straight hole passage of the brake oil of the motor simple and reliable. Compared with the prior art, the structure of the present application is simple and compact, so that the manufacturing and assembly costs may be significantly reduced, and the adaption capability of the cycloid hydraulic motor under specific application conditions is improved while keeping the original connection mode and the cross-sectional dimension substantially unchanged.

### BRIEF DESCRIPTION OF THE DRAWINGS

To illustrate the embodiments of the present disclosure or the technical solutions of the prior art more clearly, the accompanying drawings for describing the embodiments or the prior art are described briefly as follows. Apparently, the accompanying drawings in the following description are only some embodiments of the present disclosure, and persons of ordinary skill in the art, other drawings may be obtained from the disclosed accompanying drawings without creative efforts.

FIG. 1 is a cross-sectional view of a hydraulic brake motor device of an embodiment of the present application;

FIG. 2 is a right view of the hydraulic brake motor device shown in FIG. 1; and

FIG. 3 is a top view of the hydraulic brake motor device shown in FIG. 1.

### DETAILED DESCRIPTION

The technical solutions of the embodiments of the present application will be described clearly and completely below with reference to the accompanying drawings of the embodiments of the present application. Apparently, the described embodiments are only some but not all of the embodiments of the present application. On the basis of the embodiments of the present application, all other embodiments obtained by persons of ordinary skill in the art without creative efforts shall fall within the scope of the protection of the present application.

In an embodiment of the present application, a hydraulic brake motor device is disclosed. The hydraulic brake motor device includes a motor positioning, installation and driving portion, a motor body meshing pair portion, and a motor brake device portion. The motor positioning, installation and driving portion drives the motor brake device portion to operate together via the motor body meshing pair portion.

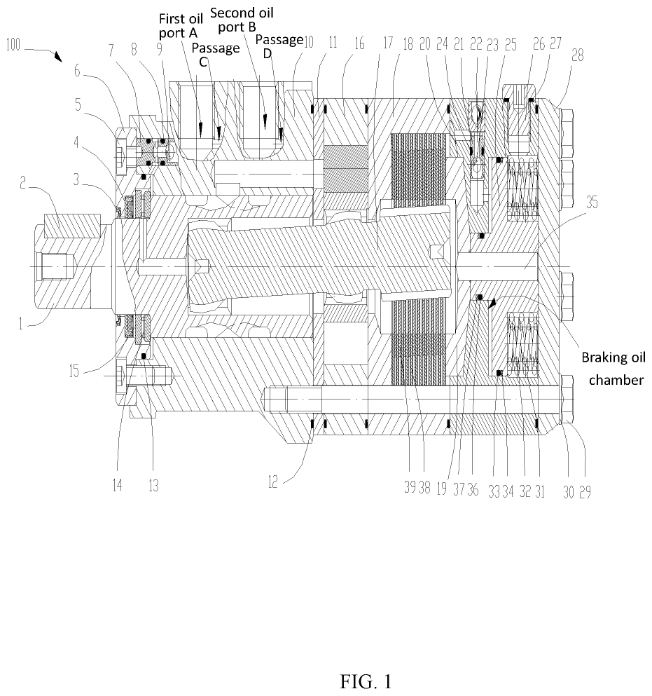

Referring to FIG. 1, the motor positioning, installation and driving portion includes an output shaft 1, a key 2, a dust-proof ring 3, a shaft seal 4, a screw 5, a front cover 6, a check valve base 7, a fourth O-ring 8, a steel ball 9, a housing 10, an partition plate 11, a fifth O-ring 12, a sixth O-ring 13, a plane bearing 14, and a third retaining ring 15. A first oil port A and a second oil port B are provided in the housing 10 and configured to carry oil. The output shaft 1 is connected to an external mechanism through the key 2. By arranging the check valve base 7, the fourth O-ring 8, and the steel ball 9, the oil can be carried only from the first oil port A and the second oil port B. The front cover 6, the check valve base 7, the housing 10, and the partition plate 11 abut against each other by means of the screw 5. By arranging the dust-proof ring 3, the shaft seal 4, the fifth O-ring 12, the sixth O-ring 13, and the third retaining ring 15, the dust-prevention and sealing of the motor positioning, installation and driving portion from external environment can be realized.

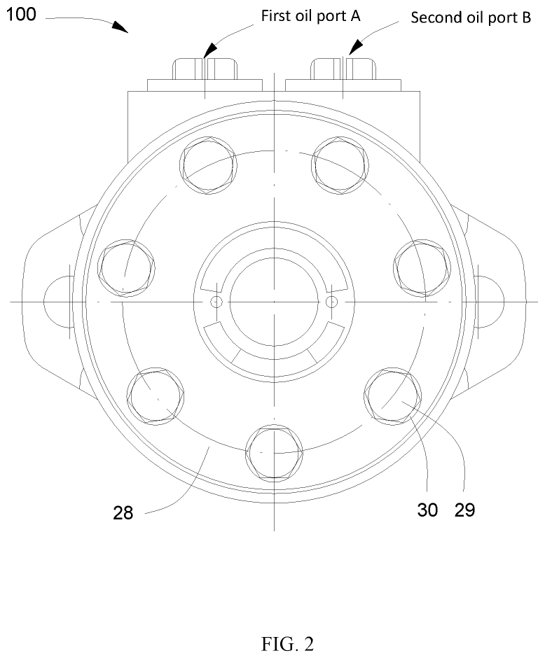

The motor body meshing pair portion includes a rotor and stator pair 16 and a linkage shaft 17. The output shaft 1 is connected with the linkage shaft 17 through the rotor and stator pair 16 and the plane bearing 14. The motor brake device portion includes a brake seat 18, a rear steel sheet 19, a brake housing 20, a valve seat 21, a tube cap 22, a steel ball 23, a first O-ring 24, a piston 25, a screw cap 26, a sealing gasket 27, a rear cover 28, connecting bolts 29, a gasket 30, a first spring 31, a second spring 32, a second O-ring 33, a first retaining ring 34, an abutting pin 35, a third O-ring 36, a second retaining ring 37, a friction sheet 38, and a steel sheet 39. The friction sheet 38 and the steel sheet 39 form a friction pair which is disposed in an inner cavity of the brake seat 18. A two-sectioned first key on the linkage shaft 17 and the output shaft 1, which engages with a key inside a rotor of the rotor and stator pair 16, extends externally to form one end engaging with a second key inside the friction pair. The location of the friction pair is limited by the connecting bolts 29 in a circumferential direction. As shown in FIG. 2, the friction pair and the rear cover 28 are fixed together by the connecting bolts 29 uniformly arranged on the rear cover 28 in a circumferential direction. The mounting space for the friction pair is large, so as to facilitate the mounting of the friction pair.

One end of the brake housing 20 of the motor brake device portion forms a stepped hole having two coaxial and stepped surfaces with circular holes. The piston 25 is provided with surfaces of a relatively large and a relatively small coaxial frustums of cones. The piston 25 is inserted into the stepped hole, and the surfaces of the relatively large and the relatively small frustums of cones engage with the two coaxial and stepped surfaces with circular holes, respectively. The surfaces of the relatively large and the relatively small frustums of cones are provided with recesses, respectively. The second O-ring 33 and the first retaining ring 34 are disposed in one recess, and the third O-ring 36 and the second retaining ring 37 are disposed in the other recess. The brake housing 20 and the piston 25 are sealed by the second O-ring 33 and the first retaining ring 34, the third O-ring 36 and the second retaining ring 37. A surface of the brake housing 20 in the radial direction of the brake housing, is spaced apart from an opposite surface of the piston 25, forming a brake oil chamber.

A shuttle valve is disposed inside the hydraulic brake motor device and configured to release pressure in the motor brake device portion. The shuttle valve includes two separate check-valve-functional parts. The two separate check-valve-functional parts are in communication with the brake oil chamber, respectively, and are in communication with the first oil port A and the second oil port B of the motor, respectively. The two separate check-valve-functional parts are disposed on the brake housing 20 between the piston 25 and the rear steel sheet 19, and arranged radially on the brake housing 20 in a radial direction. Each of the check-valve-functional parts includes a valve seat 21, a steel ball 23, a first O-ring 24, and a tube cap 22. The valve seat 21 is disposed inside the brake housing 20 and isolated from the external environment by the tube cap 22 disposed at the edge of the brake housing 20. One end of the valve seat 21 is provided with a stepped shaft and a groove. The first O-ring 24 is disposed on the stepped shaft and configured to seal the valve seat 21 and the brake housing 20. The valve seat 21 is in communication with the brake housing 20 through the groove. The steel ball 23 is mounted inside the valve seat 21. A location-limiting means is provided at one end of the valve seat 21 touching the steel ball 23, so that high-pressure oil between the steel ball 23 and the valve seat 21 has an unidirectional flow characteristic. The high-pressure oil can only flow from the brake housing 20 and flow through the groove, the valve seat 21, and the steel ball 23, but cannot flow in the opposite direction.

In some embodiments, the valve seat 21 is provided with stepped through holes therein in the radial direction of the brake housing 20. The radius of a relatively small hole of the stepped through hole is smaller than the radius of the steel ball 23. The steel ball 23 is arranged in a relatively large stepped through hole of the stepped through holes. The location-limiting means is a radius-changed region, which is adjacent to the relatively small stepped through hole of the stepped through holes. For example, the location-limiting means is region of a step of the stepped through holes adjacent to the relatively small hole of the stepped through holes. In this case, the high-pressure oil can only flow from the brake housing 20 to the brake oil chamber through the groove and the stepped through holes, so that the two check-valve-functional parts are in communication with each other through the brake oil chamber.

Further, an annular groove is arranged between the brake housing 20 and the piston 25 and configured to receive the first spring 31 and the second spring 32. The annular groove may be arranged on the piston 25, or one part of the annular groove may be arranged on the piston 25, and another part of the annular groove may be arranged on the brake housing 20. The second spring 32 is sleeved in the first spring 31. The first spring 31 and the second spring 32 abut against two surfaces of the piston 25 and the rear cover 28, respectively. The rear steel sheet 19 is partially inserted in a circular hole at an end of the brake housing 20 facing away from the piston 25. One end surface of the rear steel sheet 19 abuts against a relatively small end surface of the piston 25 by means of the abutting pin 35. When the pressure inside the brake oil chamber is insufficient to counterbalance the spring forces of the first spring 31 and the second spring 32, the piston 25 moves toward the brake housing 20 and presses the rear steel sheet 19, thus realizing the braking function of the hydraulic brake motor device.

The brake housing is provided with a first hole passage. The first hole passage is an axial passage parallel to the axial direction of the brake housing. One end of each check-valve-functional part is in communication with the brake oil chamber through the first hole passage, and the valve seat at another end guides the high-pressure oil from the first oil port A or from the second oil port B into the brake oil chamber through the stepped shaft and the groove. The first oil port A and the second oil port B are in communication with the two separate check-valve-functional parts respectively through a second hole passage, and further form an annular and closed chamber by communicating with the brake oil chamber, so as to realize the function that the hydraulic brake motor device opens a shuttle valve of the oil passage. In some embodiments, the second hole passage includes a first passage, a second passage, and a third passage. The first passage is provided in the motor positioning, installation and driving portion, and is in communication with the partition plate and the housing abutting against each other. As shown in FIG. 1, the passage C of the housing 10 is in communication with the first oil port A, and the passage D of the housing 10 is in communication with the second oil port B. The second passage is provided in the stator of the motor body meshing pair portion. The third passage is provided in the brake housing and is in communication with the brake seat. The first passage, the second passage, and the third passage are in communication with each other to form the second hole passage. The second hole passage is configured to communicate the motor positioning, installation and driving portion, the motor body meshing pair portion, and the motor brake device portion.

The two separate check-valve-functional parts skillfully utilizes a reverse action function of the high-pressure oil of the cycloid hydraulic motor check valve. When there is high-pressure oil in the first oil port A and the second oil port B, the two check-valve-functional parts are in communication with each other by means of the brake oil chamber, so that the oil passes through the check-valve-functional parts. In this way, the hydraulic brake motor device has a shuttle valve function with a controlling and braking function, thereby eliminating an external shuttle valve and a brake oil pipe of a braker, which are provided for the conventional motor. What's more, by skillfully utilizing the connecting bolts to circumferentially limit the friction pair and utilizing the externally extended first key on the linkage shaft engaging the second key inside the friction pair, the braking structure is reliable and compact. In particular, the radical arranged check-valve-functional parts make the machining process for the straight hole passage of the brake oil of the motor simple and reliable. Compared with the prior art, the structure of the present application is simple and compact, so that the manufacturing and assembly costs may be significantly reduced, and the adaption capability of the cycloid hydraulic motor under specific application conditions is improved while keeping the original connection mode and the cross-sectional dimension substantially unchanged.

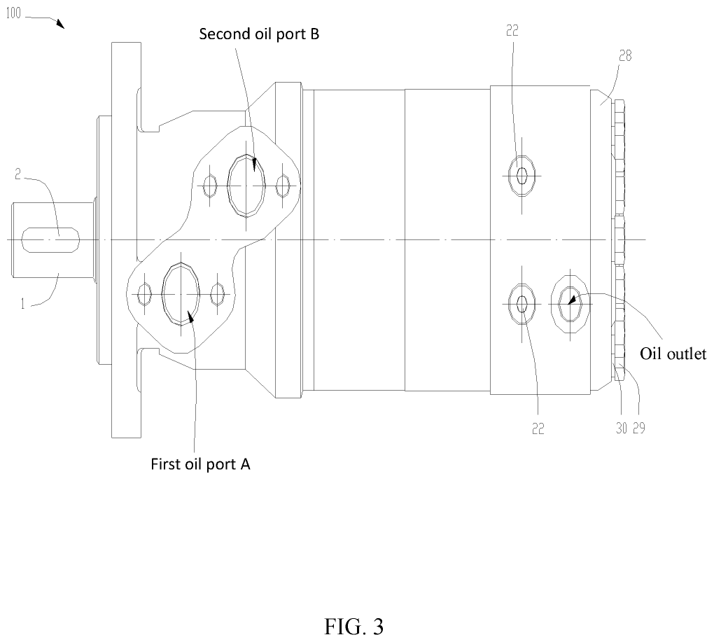

As shown in FIGS. 1, 2 and 3, the rotor and stator pair 16 includes a rotor, a stator, and needle teeth. The rear cover 28 and the piston 25 are fastened by the connecting bolts 29 and the gasket 30, and sealed by the sealing gasket 27. The two separate check-valve-functional parts each are disposed between two adjacent connecting bolts 29, and correspond to the positions of the first oil port A and the second oil port B, respectively. An oil outlet is arranged at a position where a spring in the circumferential direction of the brake housing 20 is located, and is externally connected to an oil tank at a position where the screw cap 26 is located. The oil outlet may also be arranged in the rear cover 28 and deviate from the center thereof.

At last, it should also be noted that, in this specification, the relational terms such as “first” and “second” are only used to distinguish one entity or operation from another entity or operation, and do not necessarily require or imply that there is an actual relationship or order among these entities or operations. Moreover, the terms “include”, “comprise” or any other variation thereof are intended to involve a non-exclusive inclusion, so that a process, a method, an article or a device including a series of elements includes not only those elements, but also other elements not explicitly listed, or elements inherent in such a process, a method, an article or a device. Without further restrictions, the elements defined by the expression “include” do not exclude the existence of other same elements in the process, method, article or device including the elements.

The above embodiments in this specification are described in a progressive manner. Each embodiment focuses on the differences from other embodiments. The same and similar parts among embodiments can be referred to each other.

The above description of the disclosed embodiments enables those skilled in the art to realize or use the present application. Various modifications to these embodiments will be apparent to those skilled in the art, and the general principles defined herein may be implemented in other embodiments without departing from the spirit or scope of the present application. Therefore, the present application will not be limited to these embodiments shown herein, but will conform to the widest scope consistent with the principles and creative features disclosed herein.

1. A hydraulic brake motor device comprising a motor positioning, installation and driving portion, a motor body meshing pair portion, and a motor brake device portion, wherein:
a shuttle valve is integrated inside the hydraulic brake motor device and configured to release pressure in the motor brake device portion; and
the shuttle valve comprises two separate check-valve-functional parts.

2. The hydraulic brake motor device according to claim 1, wherein:
the motor brake device portion comprises a brake housing;
each of the check-valve-functional parts comprises a steel ball, a valve seat, a first O-ring, and a tube cap;
one end of the valve seat is provided with a stepped shaft and a groove, and the valve seat is disposed inside the brake housing and isolated from an external environment by the tube cap disposed at an edge of the brake housing;
the first O-ring is disposed on the stepped shaft to seal the valve seat and the brake housing; and
a location-limiting means is provided at one end of the valve seat touching the steel ball, so that high-pressure oil between the steel ball and the valve seat has an unidirectional flow characteristic.

3. The hydraulic brake motor device according to claim 2, wherein:
the valve seat is provided with stepped through holes therein;
a radius of a relatively small hole of the stepped through holes is smaller than a radius of the steel ball;
the steel ball is arranged in a relatively large hole of the stepped through holes; and
the location-limiting means is a radius-changed region adjacent to the relatively small hole of the stepped through holes.

4. The hydraulic brake motor device according to claim 2, wherein:
the motor brake device portion further comprises a piston, a second O-ring, a first retaining ring, a third O-ring, and a second retaining ring;
one end of the brake housing forms a stepped hole;
the piston is inserted into and connected to the stepped hole of the brake housing, and two surfaces of the piston opposite to the stepped hole in an axial direction each are provided with a recess;
the second O-ring and the first retaining ring are disposed in one recess, and the third O-ring and the second retaining ring are disposed in another recess; and
a surface of the brake housing in a radial direction is spaced apart from an opposite surface of the piston to form a brake oil chamber.

5. The hydraulic brake motor device according to claim 4, wherein the two separate check-valve-functional parts are arranged radially on the brake housing in a radial direction, and are in communication with each other through the brake oil chamber.

6. The hydraulic brake motor device according to claim 5, wherein:
the motor brake device portion further comprises a rear steel sheet, a rear cover, a first spring, and a second spring;
the rear steel sheet is inserted in an end of the brake housing facing away from the piston and abuts against the piston;
an annular groove is formed on an outer wall of one end of the piston facing away from the brake housing; and
the second spring is sleeved in the first spring and disposed within the annular groove, and the first spring and the second spring abut against opposite two surfaces of the piston and the rear cover.

7. The hydraulic brake motor device according to claim 4, wherein the brake housing is provided with a first hole passage, and the check-valve-functional parts are in communication with the brake oil chamber through the first hole passage.

8. The hydraulic brake motor device according to claim 7, wherein:
the motor positioning, installation and driving portion is provided with a first oil port and a second oil port;
the motor positioning, installation and driving portion, the motor body meshing pair portion, and the motor brake device portion are provided with a second hole passage;
the check-valve-functional parts are in communication with the first oil port and the second oil port, respectively through the second hole passage.

9. The hydraulic brake motor device according to claim 8, wherein:
the motor positioning, installation and driving portion comprises a housing and a partition plate;
the first oil port and the second oil port are disposed in the housing;
the housing abuts against the partition plate;
the second hole passage comprises a first passage communicating with the partition plate and the housing, respectively, a second passage provided in a stator of the motor body meshing pair portion, and a third passage provided in the brake housing; and
the first passage, the second passage, and the third passage are in communication with each other.

10. The hydraulic brake motor device according to claim 1, wherein:
the motor body meshing pair portion comprises a rotor and stator pair and a linkage shaft;
the motor brake device portion further comprises a brake seat, a friction sheet, and a steel sheet;
the friction sheet and the steel sheet form a friction pair disposed in an inner cavity of the brake seat; a first key on the linkage shaft engages with a second key inside the friction pair; and a location of the friction pair is limited by connecting bolts arranged in a circumferential direction.

11. The hydraulic brake motor device according to claim 2, wherein the valve seat is in communication with the brake housing through the groove.

12. The hydraulic brake motor device according to claim 3, wherein the stepped through holes are arranged in the valve seat in a radial direction of the brake housing.

13. The hydraulic brake motor device according to claim 4, wherein the two surfaces of the piston opposite to the stepped hole are surfaces of a relatively large and a relatively small frustums of cones, and the surfaces of the relatively large and the relatively small frustums of cones engage with the two coaxial and stepped surfaces with circular holes, respectively.

14. The hydraulic brake motor device according to claim 6, wherein the motor body meshing pair portion further comprises an abutting pin, and one end surface of the rear steel sheet abuts against a relatively small end surface of the piston by means of the abutting pin.

15. The hydraulic brake motor device according to claim 6, wherein the two separate check-valve-functional parts are disposed on the brake housing between the piston and the rear steel sheet.

16. The hydraulic brake motor device according to claim 7, wherein the first hole passage is an axial passage parallel to the axial direction of the brake housing.

17. The hydraulic brake motor device according to claim 9, wherein the first oil port and the second oil port are in communication with the two separate check-valve-functional parts respectively through the second hole passage, and further form an annular and closed chamber by communicating with the brake oil chamber.

18. The hydraulic brake motor device according to claim 9, wherein the motor brake device portion further comprises a brake seat, and the third passage is in communication with the brake seat.

19. The hydraulic brake motor device according to claim 10, wherein the connecting bolts are uniformly arranged on a rear cover of the motor brake device portion in a circumferential direction.

20. The hydraulic brake motor device according to claim 5, wherein:
the motor brake device portion further comprises a rear steel sheet, a rear cover, a first spring, and a second spring;
the rear steel sheet is inserted in an end of the brake housing facing away from the piston and abuts against the piston;
one part of an annular groove is arranged on the piston, and another part of the annular groove is arranged on the brake housing; and
the second spring is sleeved in the first spring and disposed within the annular groove, and the first spring and the second spring abut against opposite two surfaces of the piston and the rear cover.
